(19) United States
(12) Patent Application Publication
(10) Pub. No.: US 2017/0050322 A1
(43) Pub. Date: Feb. 23, 2017

(54) FIXTURE AND SYSTEM

(71) Applicant: GM GLOBAL TECHNOLOGY OPERATIONS LLC, Detroit, MI (US)

(72) Inventors: Jianying Shi, Oakland Township, MI (US); Scott A. McLeod, Windsor (CA)

(73) Assignee: GM GLOBAL TECHNOLOGY OPERATIONS LLC, Detroit, MI (US)

(21) Appl. No.: 14/830,300

(22) Filed: Aug. 19, 2015

(51) Int. Cl. B25J 15/00; B23Q 1/26

(52) U.S. Cl. CPC B25J 15/009; B23Q 1/26

(57) ABSTRACT

A fixture includes a stand having a first and second end; a first arm attached to the stand at the first end and stationary with respect to the second end; and a first effector attached to the first arm. The first effector has a first plurality of pins and a first cap defining a first plurality of channels. Each of the first pins is retractable into and translatable out of a respective one of the first channels. The tool includes a second arm attached to the stand between the first and second ends, wherein the second arm is translatable along the stand; and a second effector attached to the second arm. The second effector has a second plurality of pins and a second cap defining a second plurality of channels. Each of the second pins is retractable into and translatable out of a respective one of the second channels.

### TECHNICAL FIELD

The disclosure relates to a fixture and a fixture system.

### BACKGROUND

A manufacturing system typically moves, transforms, or operates on parts, subassemblies, and/or assemblies that must be accurately located and held in place for manufacturing and assembly operations. For example, a sheet metal part, subassembly, or assembly may need to be accurately located and held in place to conduct assembly, welding, and inspection operations in a body shop of a vehicle assembly plant or along an assembly line for items such as appliances, aircraft, furniture, and electronics.

Part locating fixtures are normally used for this purpose. Part locating fixtures typically include a plurality of fixed pins that are configured to fit into a plurality of locating holes defined by a part, and one or more clamps that are configured to hold the part in place. Part locating fixtures are generally useable for only one particular part size and/or shape and usually need to be modified or rebuilt to locate and hold a differently sized and/or shaped part. Multiple part locating fixtures are typically required for the wide variety of parts and the wide variety of assembly and manufacturing operations in a manufacturing plant.

### SUMMARY

A fixture includes a stand having a first end, a second end spaced apart from the first end, and a longitudinal axis extending between the first end and the second end. The fixture also includes a first arm attached to the stand at the first end. The first arm is stationary with respect to the second end. The fixture further includes a first end effector attached to the first arm. The first end effector has a first cap and a first plurality of pins. The first cap defines a first plurality of channels therein, and each of the first plurality of pins is retractable into and translatable out of a respective one of the first plurality of channels. The fixture also includes a second arm attached to the stand between the first end and the second end. The second arm is translatable along the stand with respect to the first arm along the longitudinal axis. In addition, the fixture includes a second end effector attached to the second arm. The second end effector has a second cap and a second plurality of pins. The second cap defines a second plurality of channels therein, and each of the second plurality of pins is retractable into and translatable out of a respective one of the second plurality of channels.

A fixture system includes a workpiece and a fixture configured for supporting the workpiece. The workpiece has a first surface having a first contour, and a second surface adjacent the first surface having a second contour that is different from the first contour. The fixture includes a stand spaced apart from the workpiece and having a first end, a second end spaced apart from the first end, and a longitudinal axis extending between the first end and the second end. The fixture also includes a first arm attached to the stand at the first end. The first arm is stationary with respect to the second end. The fixture further includes a first end effector attached to the first arm. The first end effector has a first plurality of pins each abutting the first surface, and a first cap defining a first plurality of channels therein. Each of the first plurality of pins is retractable into and translatable out of a respective one of the first plurality of channels. The fixture also includes a second arm attached to the stand between the first end and the second end. The second arm is translatable along the stand with respect to the first arm along the longitudinal axis. The fixture also includes a second end effector attached to the second arm. The second end effector has a second cap defining a second plurality of channels therein, and a second plurality of pins each abutting the second surface. Each of the second plurality of pins is retractable into and translatable out of a respective one of the second plurality of channels.

In one embodiment, a first one of the first plurality of pins abuts the first surface and extends from the first cap to a first distance. Further, a second one of the first plurality of pins abuts the first surface and extends from the first cap to a second distance that is greater than the first distance. In addition, a first one of the second plurality of pins abuts the second surface and extends from the second cap to a third distance. Further, a second one of the second plurality of pins abuts the second surface and extends from the second cap to a fourth distance that is greater than the third distance.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of a side view of a fixture;

FIG. 2 is a schematic illustration of an end view of the fixture of FIG. 1;

FIG. 3 is a schematic illustration of a side view of a fixture system including the fixture of FIGS. 1 and 2;

FIG. 4 is a schematic illustration of a side view of an end effector of the fixture of FIGS. 1-3;

FIG. 5 is a schematic illustration of a cross-sectional view of the end effector of FIG. 4 taken along section line 5-5;

FIG. 6 is a schematic illustration of an end view of the end effector of FIG. 4; and

FIG. 7 is a schematic illustration of a partial, perspective view of a portion of the fixture system of FIG. 3.

### DETAILED DESCRIPTION

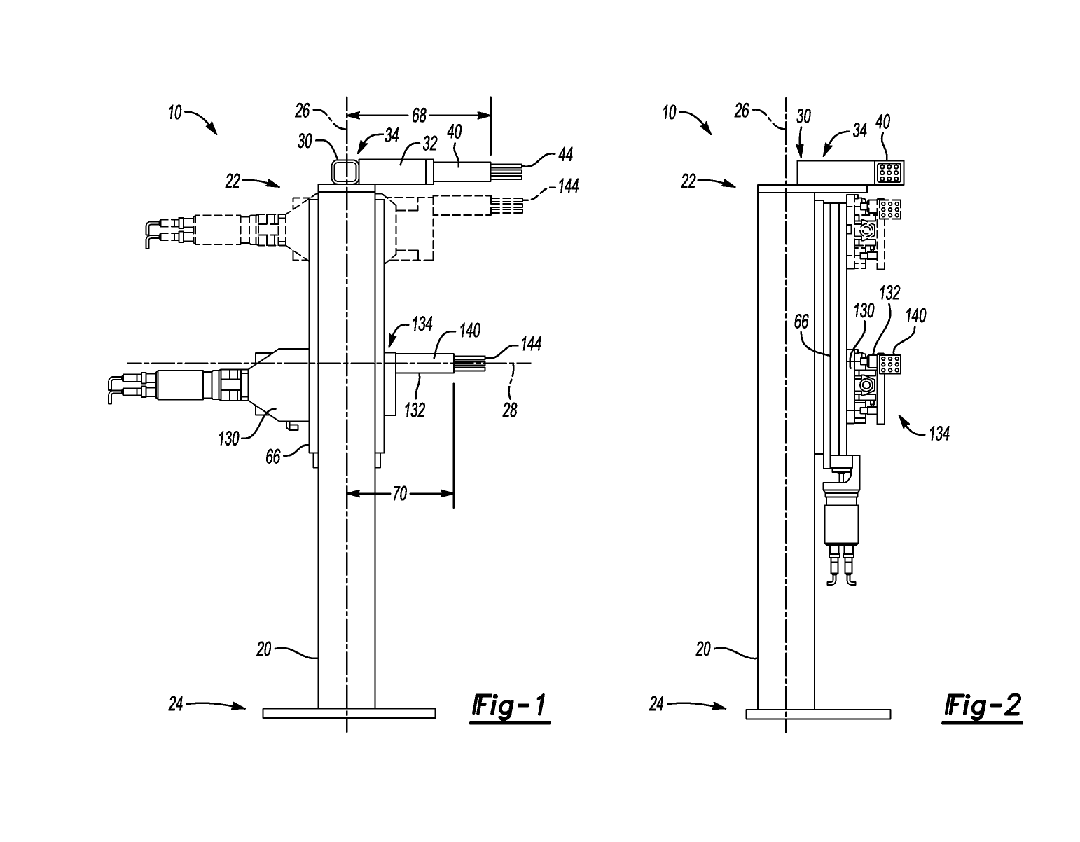

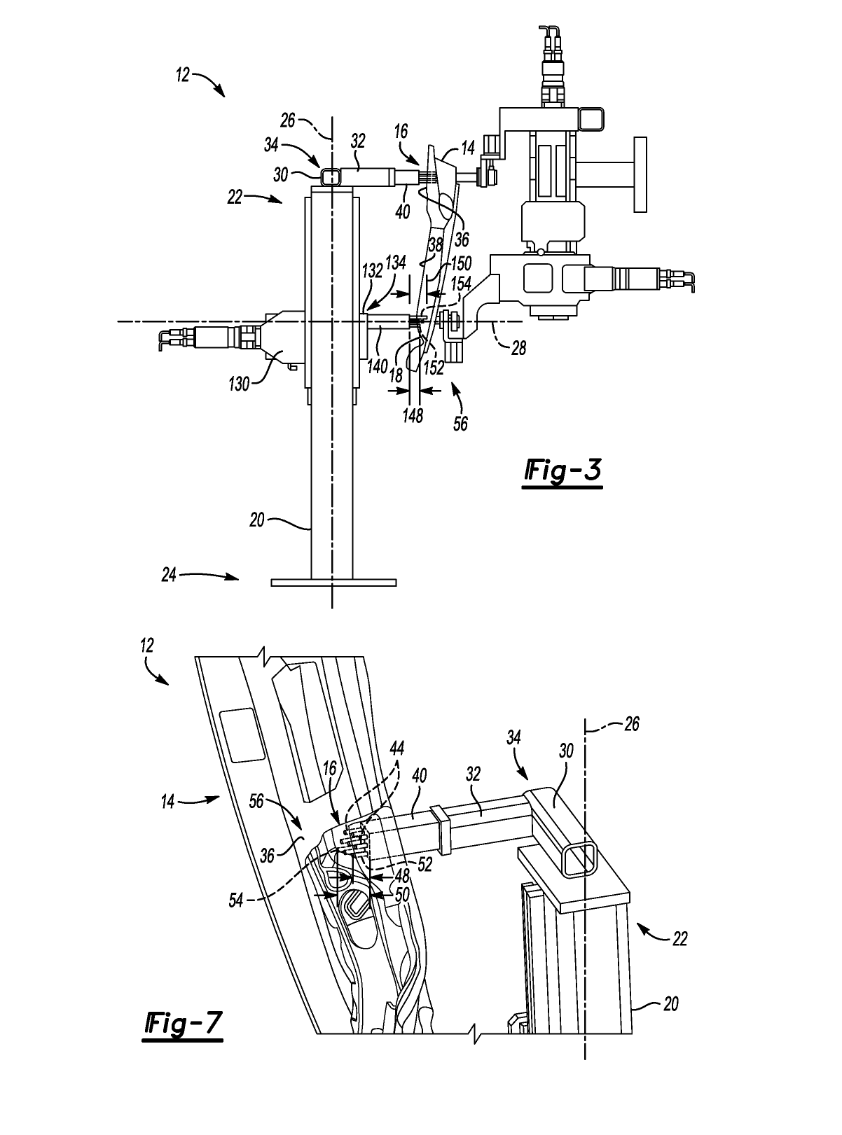

Referring to the Figures, wherein like reference numerals refer to like elements, a fixture 10 is shown generally in FIGS. 1 and 2. The fixture 10 may be a component of a fixture system 12 (FIG. 3) that may be suitable for providing one-sided clamping or support for a workpiece 14 (FIG. 3) during manufacturing operations such as welding, subassembly, assembly, picking, aligning, and the like. Therefore, the fixture 10 and fixture system 12 may be suitable for manufacturing operations and environments requiring accurate part location and placement. More specifically, the fixture 10 may be especially suitable for workpieces 14 having complex shapes or contours 16, 18 (FIG. 3). For example, the fixture 10 and fixture system 12 may be useful for assembly, welding, and inspection operations in a body shop of a vehicle assembly plant or along an assembly line for items such as, but not limited to, appliances, aircraft, furniture, and electronics.

The fixture 10 and fixture system 12 may conform to variously shaped or contoured surfaces and, as such, may be useful during part placement and/or assembly operations for, as non-limiting examples, vehicles such as automotive vehicles, construction equipment, and railcars; and consumer goods such as appliances and furniture. For example, in one non-limiting embodiment, the workpiece 14 may be a rear decklid or liftgate of an automobile, and the fixture 10 and fixture system 12 may enable flexible manufacturing processes that accommodate variously-sized and -shaped decklids and liftgates without requiring a change in physical tooling. As set forth in more detail below, the fixture 10 may be configured for supporting the workpiece 14 without compromising a structure or integrity of the workpiece 14. That is, the fixture 10 may support the workpiece 14 during manufacturing operations regardless of whether the workpiece 14 defines existing attachment or locating holes, and may provide accurate alignment of the workpiece 14 during material handling and/or welding operations.

As best shown in FIGS. 1 and 2, the fixture 10 includes a stand 20 having a first end 22 and a second end 24 spaced apart from the first end 22. Further, the stand 20 has a longitudinal axis 26 extending between the first end 22 and the second end 24. In addition, as described with reference to FIG. 1, the stand 20 may also have a latitudinal axis 28 disposed perpendicular to the longitudinal axis 26. The stand 20 may be configured for affixing to a floor or other surface, e.g., of a manufacturing facility, and may provide the workpiece 14 (FIG. 3) with a fixed support or backstop against forces applied to the workpiece 14 by other manufacturing process equipment. As such, the stand 20 may be formed from a metal, plastic, or composite according to a desired rigidity and operating environment.

As described with continued reference to FIGS. 1 and 2, the fixture 10 also includes a first arm 30 attached to the stand 20 at the first end 22. The first arm 30 may be, for example, a robotic arm, and is stationary with respect to the second end 24. That is, the first arm 30 may be fixed to the first end 22 and may not traverse along the longitudinal axis 26 or latitudinal axis 28 during operation of the fixture 10.

Further, the fixture 10 includes a first end effector 32 attached to the first arm 30, e.g., at a distal end 34 of the first arm 30. The first end effector 32 may be configured for supporting the workpiece 14 (FIG. 3) during manufacturing operations as set forth in more detail below. More specifically, the first end effector 32 may be configured for conforming to a shape of the workpiece 14 and thereby providing a support or backstop against which the workpiece 14 may rest.

For example, in one non-limiting embodiment described with reference to FIG. 3, the workpiece 14 has a first surface 36 having a first contour 16, and a second surface 38 adjacent the first surface 36 having a second contour 18 that is different from the first contour 16. For example, the workpiece 14 may be a decklid or liftgate for an automotive vehicle. Alternatively, the workpiece 14 may be a portion of an aircraft wing or a seat of an unassembled chair. The fixture 10 may accommodate various shapes and contours 16, 18 and may therefore provide for flexible manufacturing operations. That is, the fixture 10 may be useful for manufacturing operations requiring consecutive workpieces 14 having differing sizes and/or shapes. Stated differently, one fixture 10 may accommodate and support any number of workpieces 14, regardless of whether the workpieces 14 are similarly shaped or sized.

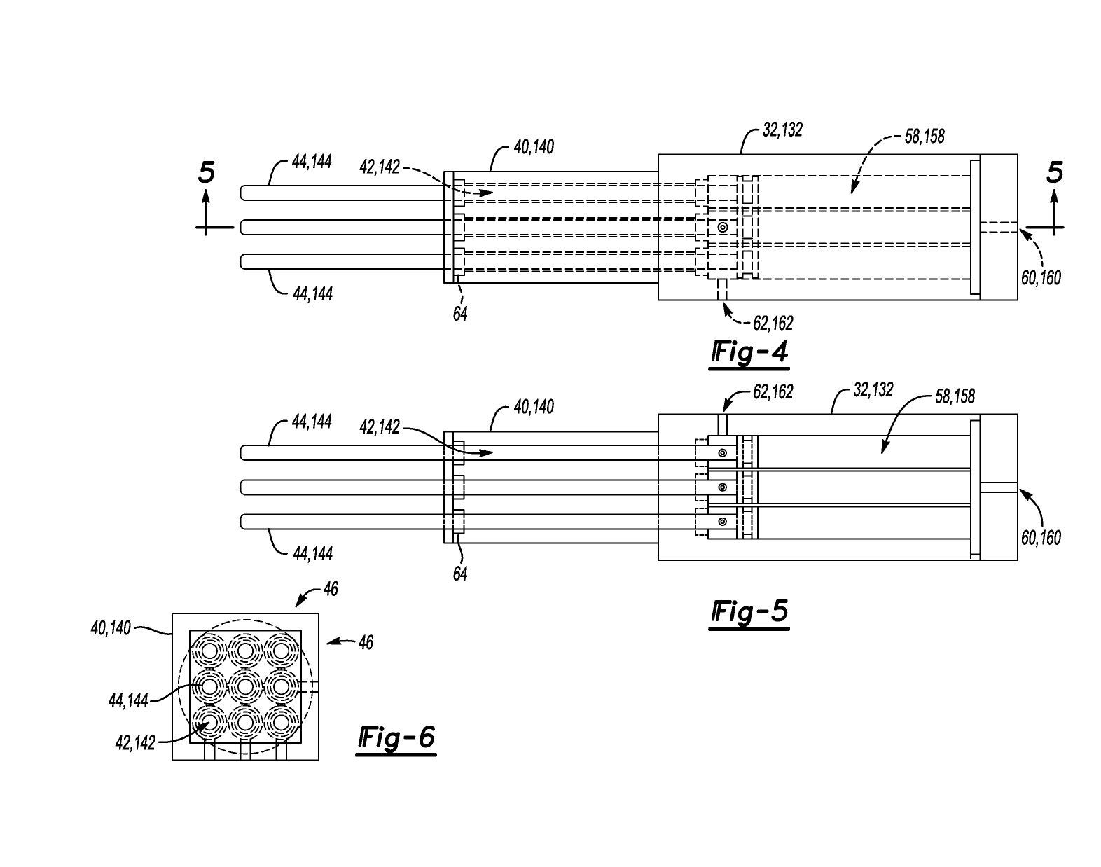

Referring now to FIGS. 4-6, the first end effector 32 has a first cap 40 defining a first plurality of channels 42 therein. Further, the first end effector 32 includes a first plurality of pins 44. For example, as best shown in FIG. 6, the first plurality of pins 44 may include nine pins 44 arranged in three rows 46 of three pins 44. That is, the first cap 40 may have a square cross-section and the first plurality of pins 44 may be arranged in a square array of three rows 46 each having three pins 44. During operation of the fixture 10, the first plurality of pins 44 may each abut the first surface 36 of the workpiece 14.

More specifically, each of the first plurality of pins 44 is retractable into and translatable out of a respective one of the first plurality of channels 42. In particular, each of the first plurality of pins 44 may be independently retractable into the respective one of the first plurality of channels 42 with respect to at least another one of the first plurality of pins 44. That is, each of the first plurality of pins 44 may separately retract into and translate out of the respective one of the first plurality of channels 42. As such, referring to FIG. 7, during operation, each of the first plurality of pins 44 may extend from the first cap 40 to a different distance 48, 50.

For example, referring to FIG. 7, a first one 52 of the first plurality of pins 44 may abut the first surface 36 and extend from the first cap 40 to a first distance 48, and a second one 54 of the first plurality of pins 44 may abut the first surface 36 and extend from the first cap 40 to a second distance 50 that is greater than the first distance 48. That is, each of the first plurality of pins 44 may be independently actuatable to a support position (shown generally at 56 in FIG. 7) in which the pin 44 contacts the workpiece 14. Therefore, the first plurality of pins 44 may each separately actuate, i.e., extend from or retract into the respective one of the first plurality of channels 42, to conform to a shape of the workpiece 14 and support an exact contour 16, 18 (FIG. 3) of the workpiece 14.

Referring again to FIGS. 4 and 5, the first cap 40 may house a first actuation system 58 configured for translating the first plurality of pins 44 into and out of the first plurality of channels 42. The first actuation system 58 may receive an actuation signal (not shown) such as an electronic or thermal activation signal and may mechanically actuate the first plurality of pins 44. In one non-limiting embodiment, the first cap 40 may define a plurality of orifices, e.g., a first inlet 60 and a first outlet 62, each configured for receiving an actuation fluid, e.g., air, water, or oil. The first actuation system 58 may further include a plurality of seals 64 configured to maintain pneumatic pressure within the first cap 40. In one example, air may independently actuate each of the first plurality of pins 44 from an initial position in which each of the first plurality of pins 44 is retracted within the first plurality of channels 42 to the support position 56 in which each of the first plurality of pins 44 is extended to abut the workpiece 14 according to a shape or contour 16, 18 (FIG. 3) of the workpiece 14. It is to be appreciated that the support position 56 for one of the first plurality of pins 44 may correspond to the first distance 48 while the support position 56 for another one of the first plurality of pins 44 may correspond to the second distance 50. That is, the support position 56 for any given pin 44 may be determined by the contour 16, 18 of the workpiece 14.

As a non-limiting example, during operation, the first plurality of pins 44 may be initially retracted into the first plurality of channels 42 in preparation for receiving the workpiece 14. Next, the workpiece 14 may be spaced opposite the first plurality of pins 44. Air may then enter the first inlet 60 at a controlled flow rate so that each of the first plurality of pins 44 extends from the respective one of the first plurality of channels 42 towards the workpiece 14 at an equal distance. Then, the workpiece 14 may translate towards the first cap 40 and eventually abut the first plurality of pins 44. Once each of the first plurality of pins 44 abuts or touches the first surface 36 (FIG. 3) of the workpiece 14, one or more of the first plurality of pins 44 may retract into the respective ones of the first plurality of channels 42 slightly to thereby adjust to the contour 16, 18 of the workpiece 14 and adequately support the workpiece 14 with a controlled force during the manufacturing operation, e.g., welding. Importantly, if the workpiece 14 were to be removed at this stage, the first plurality of pins 44 would once again extend from the first cap 40 to the equal distance. After the manufacturing operation is complete, the workpiece 14 may translate away from the first cap 40 such that the first plurality of pins 44 no longer abut the workpiece 14, and the air may exhaust from the first cap 40 through the first outlet 62 so that the first plurality of pins 44 retract into the first plurality of channels 42. Then, the next consecutive workpiece 14 of the manufacturing operation is ready to translate to a position opposite the first arm 30 so that the fixture 10 is again ready to receive the next consecutive workpiece 14.

As described with continued reference to FIGS. 1 and 2, the fixture 10 also includes a second arm 130 attached to the stand 20 between the first end 22 and the second end 24. The second arm 130 may be, for example, a robotic arm, and is translatable along the stand 20 with respect to the first arm 30 along the longitudinal axis 26. That is, the second arm 130 may translate towards and away from the first end 22 and may traverse along the longitudinal axis 26 and/or the latitudinal axis 28 during operation of the fixture 10. More specifically, the fixture 10 may include a track 66 upon which the second arm 130 travels along the longitudinal axis 26 and/or the latitudinal axis 28. Therefore, in contrast to the first arm 30 which is stationary with respect to the stand 20, the second arm 130 may be translatable along both of the longitudinal axis 26 and the latitudinal axis 28.

Further, the fixture 10 includes a second end effector 132 attached to the second arm 130, e.g., at a distal end 134 of the second arm 130. The second end effector 132 may be configured for supporting the workpiece 14 (FIG. 3) during manufacturing operations, as set forth in more detail below. More specifically, the second end effector 132 may be configured for conforming to a shape of the workpiece 14 and thereby providing a support or backstop against which the workpiece 14 may rest.

Referring now to FIGS. 4-6, the second end effector 132 has a second cap 140 defining a second plurality of channels 142 therein. Since the second arm 130 may translate along the latitudinal axis 28 (FIG. 1) while the first arm 30 is stationary with respect to the longitudinal axis 26, the first cap 40 may be spaced apart from the longitudinal axis 26 to a fixed distance 68. However, the second cap 140 may be spaced apart from the longitudinal axis 26 along the latitudinal axis 28 to a support distance 70 that is less than the fixed distance 68. Therefore, the fixture 10 and the fixture system 12 are customizable for workpieces 14 of various sizes and shapes and may enable flexible and cost-effective manufacturing.

Further, the second end effector 132 includes a second plurality of pins 144. For example, as best shown in FIG. 6, the second plurality of pins 144 may include nine pins 144 arranged in three rows 46 of three pins 144. That is, the second cap 140 may have a square cross-section and the second plurality of pins 144 may be arranged in a square array of three rows 46 each having three pins 144. During operation of the fixture 10, the second plurality of pins 144 may each abut the second surface 38 (FIG. 3) of the workpiece 14.

More specifically, each of the second plurality of pins 144 is retractable into and translatable out of a respective one of the second plurality of channels 142. In particular, each of the second plurality of pins 144 may be independently retractable into the respective one of the second plurality of channels 142 with respect to at least another one of the second plurality of pins 144. That is, each of the second plurality of pins 144 may separately retract into and translate out of the respective one of the second plurality of channels 142. As such, referring to FIG. 7, each of the second plurality of pins 144 may extend from the second cap 140 to a different distance 148, 150.

For example, referring to FIG. 3, a first one 152 of the second plurality of pins 144 may abut the second surface 38 and extend from the second cap 140 to a third distance 148, and a second one 154 of the second plurality of pins 144 may abut the second surface 38 and extend from the second cap 140 to a fourth distance 150 that is greater than the third distance 148. Further, each of the second plurality of pins 144 may be actuatable to the support position (shown generally at 56 in FIG. 3) in which the pin 144 contacts the workpiece 14. Therefore, the second plurality of pins 144 may each separately actuate, i.e., extend from or retract into the respective one of the second plurality of channels 142, to conform to a shape of the workpiece 14 and support an exact contour 16, 18 (FIG. 3) of the workpiece 14.

Referring again to FIGS. 4 and 5, the second cap 140 may also house a second actuation system 158 configured for translating the second plurality of pins 144 into and out of the second plurality of channels 142. The second actuation system 158 may receive an actuation signal (not shown) such as an electronic or thermal activation signal and may mechanically actuate the second plurality of pins 144. In one non-limiting embodiment, the second cap 140 may define a plurality of orifices, e.g., a second inlet 160 and a second outlet 162 each configured for receiving an actuation fluid, e.g., air, water, or oil. The second actuation system 158 may further include a plurality of seals 64 configured to maintain pneumatic pressure within the second cap 140. In one example, air may individually actuate each of the second plurality of pins 144 from an initial position in which each of the second plurality of pins 144 is retracted within the second plurality of channels 142 to the support position 56 (FIG. 3) in which each of the second plurality of pins 144 is extended to abut the workpiece 14 according to a shape or contour 16, 18 (FIG. 3) of the workpiece 14. It is to be appreciated that the support position 56 for one of the second plurality of pins 144 may correspond to the third distance 148 while the support position 56 for another one of the first plurality of pins 44 may correspond to the fourth distance 150. That is, the support position 56 for any given pin 144 may be determined by the contour 16, 18 of the workpiece 14.

As a non-limiting example, during operation, the second plurality of pins 144 may be initially retracted into the second plurality of channels 142 in preparation for receiving the workpiece 14. Next, the workpiece 14 may be spaced opposite the second plurality of pins 144. Air may then enter the second inlet 160 at a controlled flow rate so that each of the second plurality of pins 144 extends from the respective one of the second plurality of channels 142 towards the workpiece 14 at an equal distance. Then, the workpiece 14 may translate towards the second cap 140 and eventually abut the second plurality of pins 144. Once each of the second plurality of pins 144 abuts or touches the surface 38 (FIG. 3) of the workpiece 14, one or more of the second plurality of pins 144 may retract into the respective one of the second plurality of channels 142 slightly to thereby adjust to the contour 16, 18 of the workpiece 14 and adequately support the workpiece 14 with a controlled force during the manufacturing operation, e.g., welding. Importantly, if the workpiece 14 were to be removed at this stage, the second plurality of pins 144 would once again extend from the second cap 140 to the equal distance. After the manufacturing operation is complete, the workpiece 14 may translate away from the second cap 140 such that the second plurality of pins 144 no longer abut the workpiece 14, and the air may exhaust from the second cap 140 through the second outlet 162 so that the second plurality of pins 144 retract into the second plurality of channels 142. Then, the next consecutive workpiece 14 of the manufacturing operation is ready to translate to a position opposite the second arm 130 so that the fixture 10 is again ready to receive the next consecutive workpiece 14.

Further, it is to be appreciated that the fixture 10 and fixture system 12 may include more than two end effectors 32, 132 and more than two pluralities of pins 44, 144. For example, the fixture 10 and fixture system 12 may include three, four, or five or more end effectors 32, 132 and three, four, five, or more pluralities of pins 44, 144. Therefore, the fixture 10 and fixture system 12 may include more than two arms 30, 130, e.g., three, four, five, or more arms 30, 130. Further, more than one of the arms 30, 130 may translate along both the longitudinal axis 26 and latitudinal axis 28 during operation. As such, the fixture 10 and fixture system 12 may provide customized and precise positioning and placement of workpieces 14.

Therefore, the fixture 10 and fixture system 12 may be especially suitable for manufacturing operations which consecutively transform variously-sized and -shaped workpieces 14. More specifically, the fixture 10 and fixture system 12 provide a shape-conforming, flexible tool that transmits a controlled supporting force to the workpiece 14 during manufacturing operations. Further, since some workpieces 14 may be too wide or too contoured for a two-sided clamp, the fixture 10 provides for one-sided support during manufacturing operations.

While the best modes for carrying out the disclosure have been described in detail, those familiar with the art to which this disclosure relates will recognize various alternative designs and embodiments for practicing the disclosure within the scope of the appended claims.

1. A fixture comprising:
a stand having:
a first end;
a second end spaced apart from the first end; and
a longitudinal axis extending between the first end and the second end;
a first arm attached to the stand at the first end, wherein the first arm is stationary with respect to the second end;
a first end effector attached to the first arm and having:
a first cap defining a first plurality of channels therein; and
a first plurality of pins, wherein each of the first plurality of pins is retractable into and translatable out of a respective one of the first plurality of channels;
a second arm attached to the stand between the first end and the second end, wherein the second arm is translatable along the stand with respect to the first arm along the longitudinal axis; and
a second end effector attached to the second arm and having:
a second cap defining a second plurality of channels therein; and
a second plurality of pins, wherein each of the second plurality of pins is retractable into and translatable out of a respective one of the second plurality of channels.

2. The fixture of claim 1, wherein the stand further has a latitudinal axis disposed perpendicular to the longitudinal axis, and further wherein the second arm is translatable along the latitudinal axis.

3. The fixture of claim 1, wherein each of the first plurality of pins is independently retractable into the respective one of the first plurality of channels with respect to at least another one of the first plurality of pins.

4. The fixture of claim 3, wherein each of the second plurality of pins is independently translatable out of the respective one of the second plurality of channels with respect to at least another one of the second plurality of pins.

5. The fixture of claim 1, wherein each of the second plurality of pins in independently retractable into the respective one of the second plurality of channels with respect to at least another one of the second plurality of pins.

6. The fixture of claim 1, wherein each of the first plurality of pins is actuatable to a support position in which the pin contacts a workpiece.

7. The fixture of claim 6, wherein each of the second plurality of pins is actuatable to a support position in which the pin contacts a workpiece.

8. The fixture of claim 1, wherein a first one of the first plurality of pins extends from the first cap to a first distance, and a second one of the first plurality of pins extends from the first cap to a second distance that is greater than the first distance.

9. The fixture of claim 8, wherein a first one of the second plurality of pins extends from the second cap to a third distance, and a second one of the second plurality of pins extends from the second cap to a fourth distance that is greater than the third distance.

10. The fixture of claim 1, wherein the first plurality of pins includes nine pins arranged in three rows of three pins.

11. The fixture of claim 1, wherein the second plurality of pins includes nine pins arranged in three rows of three pins.

12. A fixture system comprising:
a workpiece having:
a first surface having a first contour; and
a second surface adjacent the first surface and having a second contour that is different from the first contour; and
a fixture configured for supporting the workpiece, the fixture including:
a stand spaced apart from the workpiece and having:
a first end;
a second end spaced apart from the first end; and
a longitudinal axis extending between the first end and the second end;
a first arm attached to the stand at the first end, wherein the first arm is stationary with respect to the second end;
a first end effector attached to the first arm and having:
a first cap defining a first plurality of channels therein; and
a first plurality of pins each abutting the first surface, wherein each of the first plurality of pins is retractable into and translatable out of a respective one of the first plurality of channels;
a second arm attached to the stand between the first end and the second end, wherein the second arm is translatable along the stand with respect to the first arm along the longitudinal axis; and
a second end effector attached to the second arm and having:
a second cap defining a second plurality of channels therein; and
a second plurality of pins each abutting the second surface, wherein each of the second plurality of pins is retractable into and translatable out of a respective one of the second plurality of channels.

13. The fixture system of claim 12, wherein the stand further has a latitudinal axis disposed perpendicular to the longitudinal axis, and further wherein the second arm is translatable along the latitudinal axis.

14. The fixture system of claim 13, wherein the first cap is spaced apart from the longitudinal axis to a fixed distance, and further wherein the second cap is spaced apart from the longitudinal axis along the latitudinal axis to a support distance that is less than the fixed distance.

15. The fixture system of claim 13, wherein:
each of the first plurality of pins is independently retractable into the respective one of the first plurality of channels with respect to at least another one of the first plurality of pins; and
each of the second plurality of pins is independently retractable into the respective one of the second plurality of channels with respect to at least another one of the second plurality of pins.

16. The fixture system of claim 12, wherein a first one of the first plurality of pins abuts the first surface and extends from the first cap to a first distance, and further wherein a second one of the first plurality of pins abuts the first surface and extends from the first cap to a second distance that is greater than the first distance.

17. The fixture system of claim 12, wherein a first one of the second plurality of pins abuts the second surface and extends from the second cap to a third distance, and further wherein a second one of the second plurality of pins abuts the second surface and extends from the second cap to a fourth distance that is greater than the third distance.

18. A fixture system comprising:
a workpiece having:
a first surface having a first contour; and
a second surface adjacent the first surface and having a second contour that is different from the first contour; and
a fixture configured for supporting the workpiece, the fixture including:
a stand spaced apart from the workpiece and having:
a first end;
a second end spaced apart from the first end; and
a longitudinal axis extending between the first end and the second end;
a first arm attached to the stand at the first end, wherein the first arm is stationary with respect to the second end;
a first end effector attached to the first arm and having:
a first cap defining a first plurality of channels therein; and
a first plurality of pins each abutting the first surface, wherein each of the first plurality of pins is retractable into and translatable out of a respective one of the first plurality of channels;
wherein a first one of the first plurality of pins abuts the first surface and extends from the first cap to a first distance, and further wherein a second one of the first plurality of pins abuts the first surface and extends from the first cap to a second distance that is greater than the first distance;
a second arm attached to the stand between the first end and the second end, wherein the second arm is translatable along the stand with respect to the first arm along the longitudinal axis; and
a second end effector attached to the second arm and having:
a second cap defining a second plurality of channels therein; and
a second plurality of pins each abutting the second surface, wherein each of the second plurality of pins is independently retractable into and independently translatable out of a respective one of the second plurality of channels;
wherein a first one of the second plurality of pins abuts the second surface and extends from the second cap to a third distance, and further wherein a second one of the second plurality of pins abuts the second surface and extends from the second cap to a fourth distance that is greater than the third distance.

19. The fixture system of claim 18, wherein the stand further has a latitudinal axis disposed perpendicular to the longitudinal axis, and further wherein the second arm is translatable along the latitudinal axis.
